(19) United States
(12) Patent Application Publication
(10) Pub. No.: US 2021/0192973 A1
(43) Pub. Date: Jun. 24, 2021

(54) SYSTEMS AND METHODS FOR GENERATING PERSONALIZED ASSIGNMENT ASSETS FOR FOREIGN LANGUAGES

(71) Applicant: Talaera LLC, New York, NY (US)

(72) Inventors: Mel MACMAHON, Jersey City, NJ (US); Anita ANTHONJ, Jersey City, NJ (US); Jens TROEGER, Duvall, WA (US); Ljubomir BRADIC, Seattle, WA (US); Kristina LALIBERTE, West Brookfield, MA (US)

(21) Appl. No.: 16/720,254

(22) Filed: Dec. 19, 2019

(51) Int. Cl. G09B 19/06; G06K 9/62; G09B 7/00; G06N 3/08; G06F 16/335

(52) U.S. Cl. CPC G09B 19/06; G06K 9/6256; G06F 16/337; G06N 3/088; G09B 7/00

(57) ABSTRACT

Methods and systems are provided for personalizing foreign language instruction. In particular, the systems and methods provided apply artificial intelligence to novel tasks related to teaching foreign languages such as detecting skill levels of users, generating personalized course curriculums for individual users based on the learning goals and initial skill level of a user, generating custom assignment assets for those goals based on current strengths, weakness, generating content for custom questions for those assignment assets, and dynamically tracking and updating the skill level of the user during the course.

### FIELD OF THE INVENTION

The invention relates to personalizing assignment assets for learning foreign languages through the use of artificial intelligence.

### BACKGROUND

In today's international world, people routinely look to learn a new language. Whether for business or pleasure, learning a new language can be greatly rewarding and innately difficult. While books and computer programs have been developed to help teach foreign languages, these books and computer programs fall short of in-person instructors and classrooms as they are not personalized to a given user. The more personalized a course is the more the student is engaged and the more engaged a student is, the more successful they will be at acquiring the skills they seek to develop

### SUMMARY

Accordingly, methods and systems are provided herein for personalizing foreign language instruction. Specifically, embodiments disclosed herein relate to a personalized teaching method and system that harness the advantages of in-person and one-on-one attention for a given user while still providing a fully scalable environment. For example, through the creation of personalized training courses, assignment assets, and content for questions that populate those assignment assets, the methods and systems described herein may provided a fully immersive and dynamic learning experience that is customized to the strengths, weakness, and interests of a given user.

To achieve these benefits, the systems and methods provided herein build upon recent advances in artificial intelligence. In particular, the systems and methods provided herein apply artificial intelligence to novel tasks related to teaching foreign languages such as detecting skill levels of users, generating personalized course curriculums for individual users based on the learning goals and initial skill level of a user, generating custom assignment assets for those goals based on current strengths, weakness, generating content for custom questions for those assignment assets, and dynamically tracking and updating the skill level of the user during the course. Moreover, systems and methods provided herein tailor machine learning models and algorithms for the novel tasks mentioned above. For example, in addition to training the machine learning models and algorithms for specific classifications related to these tasks, the systems and methods described herein use one or more machine learning models and algorithms selected for their specific functions and ordered accordingly to generate the specific inputs and outputs for the various applications above.

Notably, as opposed to prior systems that attempt to organize existing information into a course format suitable for learning foreign languages (e.g., selecting particular assignments on particular topics, arranging assignments in particular orders, etc.), the methods and systems described herein generate new content that integrate with existing materials to create new assignment assets that are personalized as described above. For example, in one embodiment, the methods and systems parse existing materials (e.g., news publications, literature, audio works, etc.) that may be of interest to the user for areas in which content generated for specifically determined purposes (e.g., corresponding to the learning goals of the user) may be intertwined in order to generate new materials that both meet the learning goals of the user and preserve the subject matter of the materials. Moreover, through the system and methods discussed below, the system may determine a skill level of a user based on the user actions of that user despite the user actions being performed on assignment assets that are personalized for that user (and may or may not be similar to those of other users).

In some aspects, the system may comprise determining a user skill level while teaching foreign languages. For example, the system may receive a first user action from a first user that is interacting with a first assignment asset, wherein the first user action has a first characteristic. The system may then generate a first array based on the first user action and label the first array with a known user skill level. The system may then train an artificial neural network to detect the known user skill level on the labeled first array. The system may then receive a second user action from a second user that is interacting with a second assignment asset, wherein the second user action has a second characteristic. The system may then generate a second array based on the second user action and input the second array into the trained neural network. The system may then receive an output from the trained neural network indicating that the second user has the known user skill level.

Additionally or alternatively, in some aspects, the system may receive a first user action from a first user that is interacting with a first assignment asset, wherein the first user action has a first characteristic. The system may then label first user action with a known user skill level and train a machine learning model to detect the known user skill level on the labeled first user action. The system may then receive a second user action from a second user that is interacting with a second assignment asset, wherein the second user action has a second characteristic, and the system may input the second user action into the trained machine learning model. The system may then receive an output from the trained machine learning model indicating that the second user has the known user skill level.

Additionally or alternatively, in some aspects, the system may generate foreign language questions for learning foreign languages using natural language processing. The system may retrieve a subject matter preference of a user from a user profile. The system may then select an assignment asset corresponding to the subject matter preference and process the assignment asset using a part-of-speech tagging algorithm to label a first word of the assignment asset as corresponding to a first part-of-speech type and a second word of the assignment asset as corresponding to a second part-of-speech type. The system may then select a part-of-speech type for testing in the assignment asset; determining that the first part-of-speech type corresponds to the part-of-speech type for testing, and the system may generate content for a foreign language question corresponding to the first word in response to determining that the first part-of-speech type corresponds to the part-of-speech type for testing.

Additionally or alternatively, in some aspects, the system may retrieve a subject matter preference of a user from a user profile, and select a first assignment asset and a second assignment asset corresponding to the subject matter preference. The system may then process the first assignment asset using a first summation algorithm to generate a first summation of the first assignment asset and processing the second assignment asset using a second summation algorithm to generate a second summation of the second assignment asset. The system may then generate content for a foreign language question using the first summation and a second summation.

Various other aspects, features, and advantages of the invention will be apparent through the detailed description of the invention and the drawings attached hereto. It is also to be understood that both the foregoing general description and the following detailed description are exemplary and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Finally, while the embodiments and examples described herein related to learning foreign languages, it should be noted that alternative or additional learning and/or entertainment objectives may be achieved. For example, the embodiments and examples described herein may be used to generate content for any learning and/or entertainment objective.

### BRIEF DESCRIPTION OF THE DRAWINGS

FIG. 1 shows an illustrative system for learning foreign languages using an electronic device, in accordance with one or more embodiments.

FIG. 2 shows a system diagram featuring a machine learning model configured to facilitate learning foreign languages, in accordance with one or more embodiments.

FIG. 3 shows a system diagram for generating personalized assignment assets, in accordance with one or more embodiments.

FIG. 4 shows a system diagram for dynamically creating personalized assignment assets, in accordance with one or more embodiments.

FIG. 5 shows a system diagram for generating content based on the strengths, weakness, and/or skill level of users, in accordance with one or more embodiments.

FIG. 6 shows a flowchart of steps for determining a user skill level while teaching foreign languages using a trained neural network, in accordance with one or more embodiments.

FIG. 7 shows a flowchart of steps for determining a user skill level while teaching foreign languages using a machine learning model, in accordance with one or more embodiments.

FIG. 8 shows a flowchart of steps for generating foreign language questions for learning foreign languages with natural language processing using a part-of-speech tagging algorithm, in accordance with one or more embodiments.

FIG. 9 shows a flowchart of steps for generating foreign language questions for learning foreign languages with natural language processing using a summation algorithm, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other instances, well-known structures and devices are shown in block diagram form in order to avoid unnecessarily obscuring the embodiments of the invention.

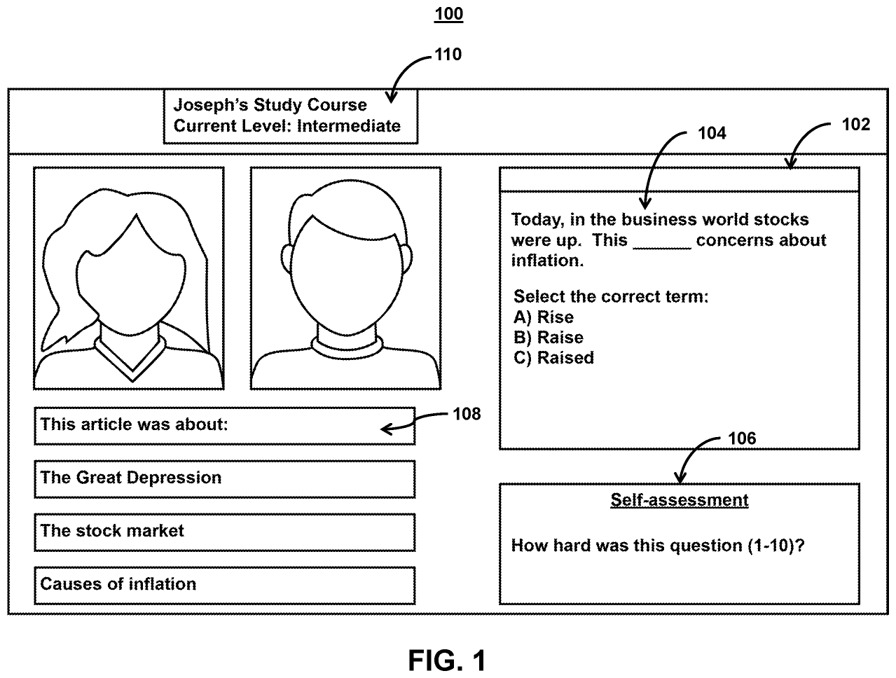

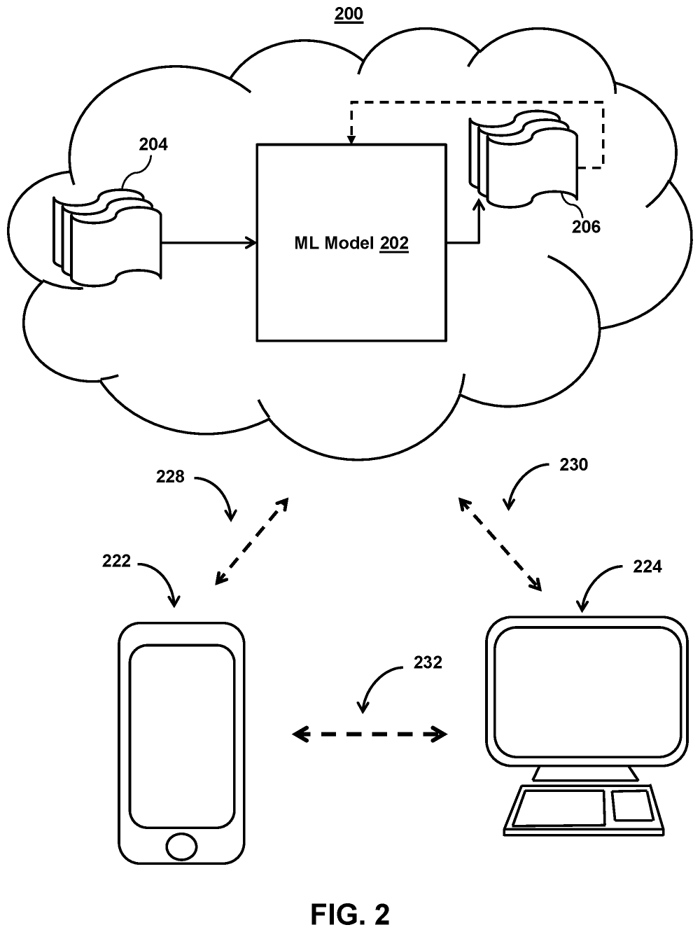

FIG. 1 shows an illustrative system for learning foreign languages using an electronic device, in accordance with one or more embodiments. For example, FIG. 1 shows user interface 100. User interface 100 may represent an example of a user interface that appears on a user device (e.g., device 222 or device 224 (FIG. 2) as a user interacts with a foreign language application. User interface 100 may include any means by which the user and a computer system interact. User interface 100 may include multiple input and/or output devices and may be run using software.

User interface 100 currently displays user profile 110. User profile 110 may identify the name and/or personal information about a user. Additionally or alternatively, user profile 110 may include information specific to the user. This may include geographic and/or demographic information as well as the native language and/or a goal language. User profile 110 may also include a current user skill level and/or the specific strengths, weakness, and/or interests of the users. User profile 110 may accumulate this information either actively or passively. For example, user profile 110 may be populated by information gathered directly from a user (e.g., via questionnaires) or information that is automatically (e.g., by monitoring one or more user actions). User profile 110 may also include information received about the user from third-party sources. User profile 110 may also include personality traits, social and behavioral information, and consumer information (e.g., buying habits, debt levels, previous exposure to advertisements and/or the results of that exposure to advertisements). This information in user profile 110 may be used by the system to tailor the learning experience of the user and generate personalized assignment assets for the user. For example, user profile 110 may include a subject matter preference. Based on this subject matter preference, the system may select assignment assets that meet this preference.

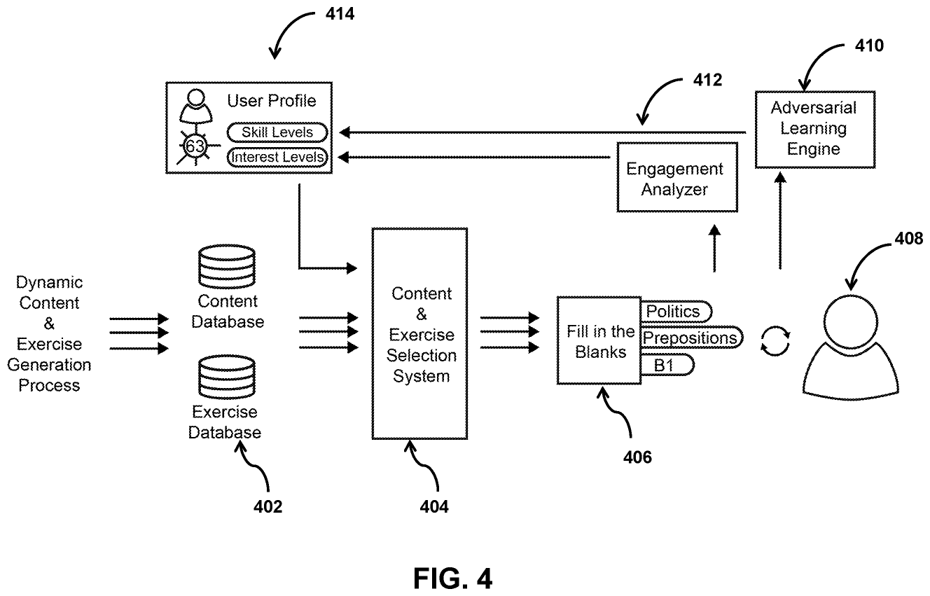

User profile 110 may comprise a course curriculum for the user. The course curriculum may include a series of assignments and/or topics to be taught to the user. The curriculum may be dynamic, static, or a hybrid. For example, the system may generate a course curriculum when the user creates user profile 110. This curriculum may be based on inputted goals received from the user. The system may then generate a predetermine series of assignments, each featuring personalized content in the form of questions. Additionally or alternatively, the system may dynamically update the curriculum as the user progresses. For example, the system may monitor the user actions of the user to determine a skill level of the user. The system may then update the curriculum, assignments, and/or questions based on the current skill level of the user. For example, as described below in relation to FIG. 4, the system may recommend and generate content for the user.

The system may monitor a plurality of user actions. User action may include any active or passive action taken by the user while interacting with the application. For example, user actions may include user inputs of the user such as highlighting, translating, and/or requesting a definition for words (e.g., in an assignment asset), requesting additional information (e.g., in response to a question), selecting correct (or incorrect) answers, etc. In addition to monitoring user actions, the system may monitor characteristics of user actions. Characteristics of user actions may include any feature or trait of the user action. For example, a characteristic may include the length of time of a user action (e.g., how long a user read an assignment asset or deliberated over a question), the frequency of a user action (e.g., how many times a user requested a translation of a word or a type of word), the number of a user action (e.g., the number of times a user chose a correct or incorrect answer), etc.

In addition to monitoring user actions and the characteristics of those user actions the system may track an assignment asset, question, word, and/or other subject matter corresponding to the user action. For example, the system may store the assignment asset or word subject to the user action for use in personalizing future content and/or determining the skill level of the user as described in FIG. 4 below. The system may, e.g., determine a difficulty of an assignment asset based on the user actions associated with it. Likewise, the system may determine a skill level of the user based on the difficulty of an assignment asset that was subject to a user action.

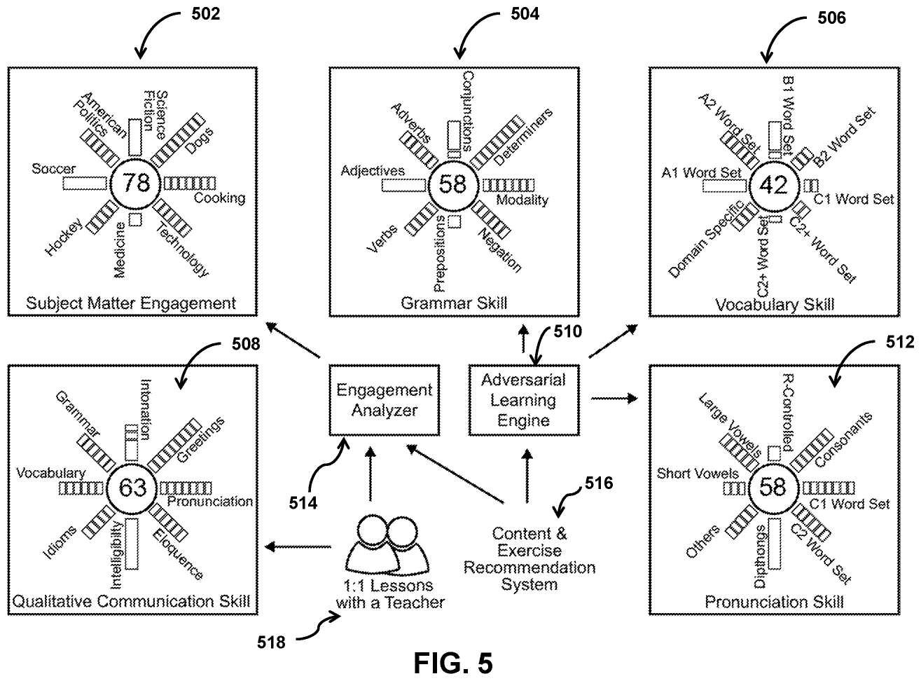

The system may track and determine a skill level of the user. The skill level of the user may be a quantitative or qualitative assessment of the user's mastering of a given foreign language. In some embodiments, the system may track an overall skill level and/or one or more other skill levels (e.g., corresponding to a user's mastery of a particular part-of-speech). For example, as described in relation to FIG. 5 below, the system may track multiple skill levels of the user, each corresponding to one category related to learning a foreign language. For example, each category may correspond to a different part-of-speech and/or a different skill set. The system may then aggregate these various category skills to determine an overall skill level of the user.

The system may also allow a user to provide a self-assessment (e.g., via question 106). The system may use this self-assessment to directly influence the skill level of the user. For example, in response to a correct answer and/or a user self-assessment that the question was easy, the system may increase the skill level of the user. In another example, in response to an incorrect answer and/or a user self-assessment that the question was easy, the system may retrieve the skill level of similar user that provide similar answers to the self-assessment. The system may then determine that the user has the same skill level as the other users (or an average of the skill level of the other users). In some embodiments, the system may store both the self-assessment of the user and the current determined skill level of the user. The system may then use both pieces of information to determine a new skill level of the user and/or the skill level of an assignment asset. For example, the system may determine that a user with a first skill level (e.g., “low”) that gives a first self-assessment (e.g., “assignment was easy”) is often incorrect. In contrast, the system may determine that a user with a second skill level (e.g., “high”) that gives a second self-assessment (e.g., “assignment was hard”) is often correct. That is, the system may determine that the currently determined skill level of the user may be a reliable metric for determining the accuracy of the self-assessment.

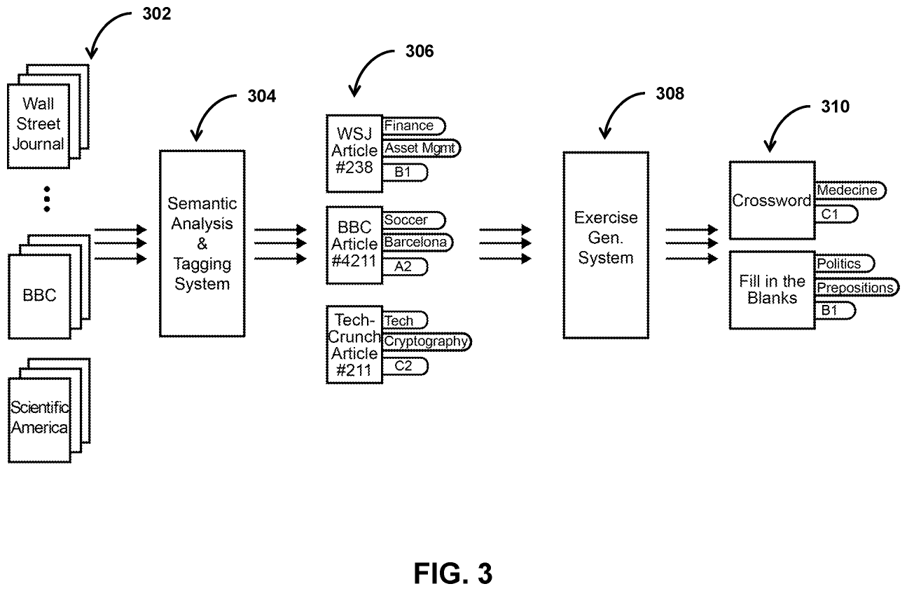

The system may generate content and/or assets for the user. “Assets” and “content” may include Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media. In some embodiments (as described below in relation to FIG. 3), the system may receive assets (e.g., news publications, literature, etc.) and use these assets to generate assignment assets (e.g., assets that comprise an assignment of a course curriculum assigned to a user).

The generated content may take the form of a question (e.g., as described in FIG. 3 below). The question may have a plurality of formats. For example, as shown in FIG. 1, question 102 requests the user enter a word for blank space 104. In contrast, question 108 requests a user to summarize a given article. For example, the question may be posed as a fill in the blank, multiple choice, reading comprehension, true/false, essay, voice input, etc. The user may receive the question via reading user interface 100 and/or hearing an audio output. The user may likewise input an answer to the question via user interface 100. In some embodiments, the generate content may include a modification to a previous publication. For example, the system may generate personalized assignment assets by modifying and/or intertwined personalized content into a previously published work.

FIG. 2 shows a system diagram featuring a machine learning model configured to facilitate learning foreign languages, in accordance with one or more embodiments. As shown in FIG. 2, system 200 may include user device 222, user device 224, and/or other components. Each user device may include any type of mobile terminal, fixed terminal, or other device. Each of these devices may receive content and data via input/output (hereinafter “I/O”) paths and may also include processors and/or control circuitry to send and receive commands, requests, and other suitable data using the I/O paths. The control circuitry may be comprised of any suitable processing circuitry. Each of these devices may also include a user input interface and/or display for use in receiving and displaying data (e.g., user interface 100 (FIG. 1)). By way of example, user device 222 and user device 224 may include a desktop computer, a server, or other client device. Users may, for instance, utilize one or more of the user devices to interact with one another, one or more servers, or other components of system 200. It should be noted that, while one or more operations are described herein as being performed by particular components of system 200, those operations may, in some embodiments, be performed by other components of system 200. As an example, while one or more operations are described herein as being performed by components of user device 222, those operations may, in some embodiments, be performed by components of user device 224. System 200 also includes machine learning model 202, which may be implemented on user device 222 and user device 224, or accessible by communication paths 228 and 230, respectively. It should be noted that, although some embodiments are described herein with respect to machine learning models, other prediction models (e.g., statistical models or other analytics models) may be used in lieu of, or in addition to, machine learning models in other embodiments (e.g., a statistical model replacing a machine learning model and a non-statistical model replacing a non-machine learning model in one or more embodiments).

Each of these devices may also include memory in the form of electronic storage. The electronic storage may include non-transitory storage media that electronically stores information. The electronic storage of media may include (i) system storage that is provided integrally (e.g., substantially non-removable) with servers or client devices and/or (ii) removable storage that is removably connectable to the servers or client devices via, for example, a port (e.g., a USB port, a firewire port, etc.) or a drive (e.g., a disk drive, etc.). The electronic storages may include optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

FIG. 2 also includes communication paths 228, 230, and 232. Communication paths 228, 230, and 232 may include the Internet, a mobile phone network, a mobile voice or data network (e.g., a 4G or LTE network), a cable network, a public switched telephone network, or other types of communications network or combinations of communications networks. Communication paths 228, 230, and 232 may include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

As an example, with respect to FIG. 2, machine learning model 202 may take inputs 204 and provide outputs 206. The inputs may include multiple data sets such as a training data set and a test data set. Each of the plurality of data sets (e.g., inputs 204) may include data subsets with common characteristics. The common characteristics may include characteristics about a user, assignments, user actions, and/or characteristics of a user actions. In some embodiments, outputs 206 may be fed back to machine learning model 202 as input to train machine learning model 202 (e.g., alone or in conjunction with user indications of the accuracy of outputs 206, labels associated with the inputs, or with other reference feedback information). In another embodiment, machine learning model 202 may update its configurations (e.g., weights, biases, or other parameters) based on the assessment of its prediction (e.g., outputs 206) and reference feedback information (e.g., user indication of accuracy, reference labels, or other information). In another embodiment, where machine learning model 202 is a neural network, connection weights may be adjusted to reconcile differences between the neural network's prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine learning model 202 may be trained to generate better predictions.

In some embodiments, machine learning model 202 may include an artificial neural network. In such embodiments, machine learning model 202 may include input layer and one or more hidden layers. Each neural unit of machine learning model 202 may be connected with many other neural units of machine learning model 202. Such connections can be enforcing or inhibitory in their effect on the activation state of connected neural units. In some embodiments, each individual neural unit may have a summation function which combines the values of all of its inputs together. In some embodiments, each connection (or the neural unit itself) may have a threshold function such that the signal must surpass before it propagates to other neural units. Machine learning model 202 may be self-learning and trained, rather than explicitly programmed, and can perform significantly better in certain areas of problem solving, as compared to traditional computer programs. During training, an output layer of machine learning model 202 may corresponds to a classification of machine learning model 202 (e.g., whether or not a user action of a user corresponds to a predetermined skill level) and an input known to correspond to that classification may be input into an input layer of machine learning model 202 during training. During testing, an input without a known classification may be input into the input layer, and a determined classification may be output.

In some embodiments, machine learning model 202 may include multiple layers (e.g., where a signal path traverses from front layers to back layers). In some embodiments, back propagation techniques may be utilized by machine learning model 202 where forward stimulation is used to reset weights on the “front” neural units. In some embodiments, stimulation and inhibition for machine learning model 202 may be more free-flowing, with connections interacting in a more chaotic and complex fashion. During testing, an output layer of machine learning model 202 may indicate whether or not a given input corresponds to a classification of machine learning model 202 (e.g., whether or not a word corresponds to a particular part-of-speech).

In some embodiments, machine learning model 202 may comprise a convolutional neural network. The convolutional neural network is an artificial neural network that features one or more convolutional layers. Convolution layers extract features from an input (e.g., a document). Convolution preserves the relationship between pixels by learning image features using small squares of input data. For example, the relationship between the individual portions of a document. In some embodiments, machine learning model 202 may comprise an adversarial neural network (e.g., as described in-depth in relation to FIG. 4). For example, machine learning model 202 may comprise a plurality of neural networks, in which the neural networks are pitted against each other in an attempt to spot weaknesses in the other.

System 200 may also include additional components for generating personalized assignment assets, dynamically creating personalized assignment assets, and/or generating content based on the strengths, weakness, and/or skill level of users as described in FIGS. 3-5 below.

FIG. 3 shows a system diagram for generating personalized assignment assets, in accordance with one or more embodiments. For example, as shown in FIG. 3, the system may retrieve available content and assets 302. Available content and assets 302 may be published and publicly available content. Additionally or alternatively, available content and assets 302 may include content retrieved from one or more licensed sources. In some embodiments, the system may invoke web crawlers and/or content aggregators to populate a data store of available content.

In some embodiments, the retrieved available content and assets 302 may be filtered based on the user. For example, the system may use a data set for the user that is selected based on the ultimate goal of the user (e.g., a user training as an English lawyer may have a data set featuring legal articles, a user training as a French cook may have a data set featuring French cookbooks, etc.). Accordingly, the words, phrases, and uses of language learned by the user is relevant to the goals of the user.

The system may then apply semantic analysis and tagging system 304 to the content. For example, the system may apply latent semantic analysis, latent semantic indexing, Latent Dirichlet allocation, and/or n-grams and hidden Markov models to available content and assets 302. System 304 may assign descriptive tags to the content that indicate the complexity, subject matter, meaning of the content to generate tagged content 306. During this natural language processing, the system may incorporate one or more of the machine learning and/or artificial neural networks as described in FIG. 2.

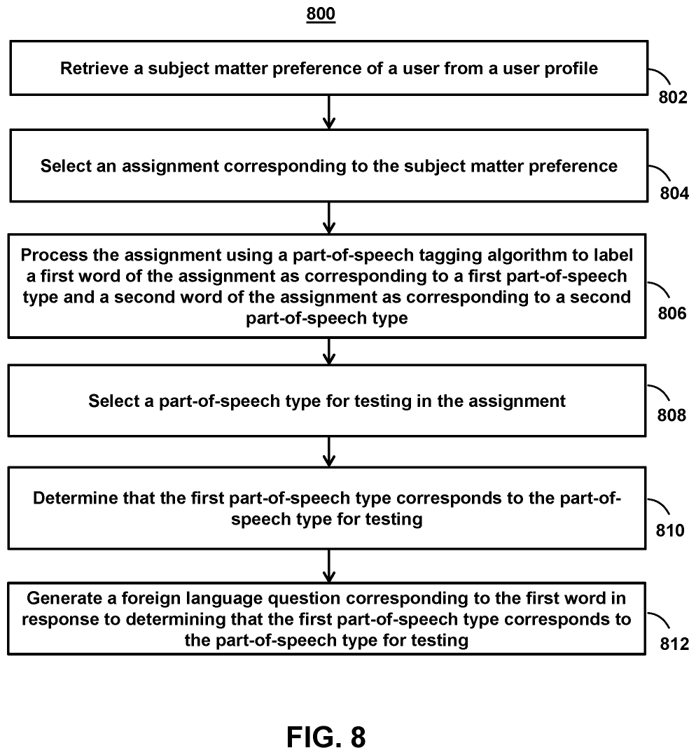

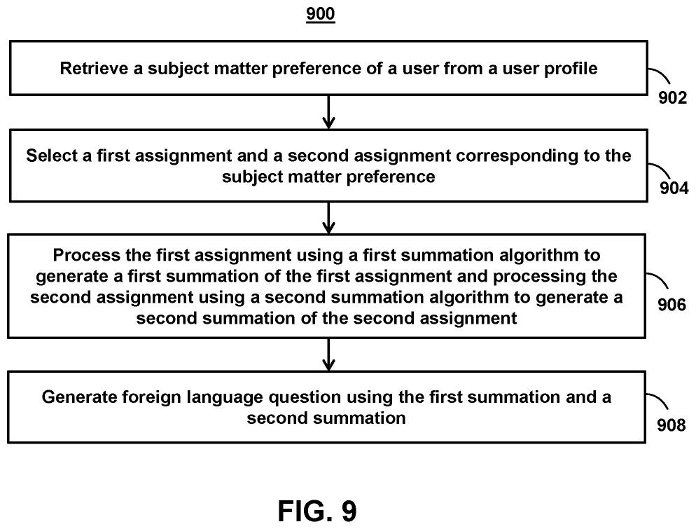

Tagged content 306 may include a plurality of descriptive tags. The descriptive tags may indicate keywords associated with tagged content 306, the skill level (e.g., based on complexity) of tagged content 306, and may include an individual identifier for tagged content 306. For example, the descriptive tags associated with tagged content 306 may be used to match tagged content 306 to subject matter preferences of a user when selecting an assignment asset (e.g., as described below in FIGS. 8-9).

The system may then process tagged content 306 through assignment generation system 308. In some embodiments, the system may process tagged content 306 in response to a user requesting an assignment asset, a course curriculum being generated that itself requests an assignment asset, and/or in response to a dynamic update of the course curriculum that includes a request for an assignment asset. Assignment generation system 308 may process the content of tagged content 306 to structuring analyze it, apply part-of-speech tagging (e.g., as described in FIG. 8 below), apply summation analysis (e.g., as described in FIG. 9 below), and/or other generate content for foreign language questions. For example, assignment generation system 308 may determine a definition and context (e.g., a relationship with adjacent and related words in a phrase, sentence, or paragraph) of a word to determine its part-of-speech type. Additionally or alternatively, assignment generation system 308 may generate a summary of tagged content 306 and/or multiple summaries of the same tagged content 306 (e.g., corresponding to different skill levels). Assignment generation system 308 may use multiple criteria such as the skill level of the user, the skill level of the assignment asset, and the focus area (e.g., part-of speech type being targeted).

The system may then store the output of assignment generation system 308 in assignment asset storage 310. Assignment asset storage 310 may store the assignment assets and/or questions for use in populating the assignment assets in a categorized manner that may be accessed by the system when recommending assignment assets and/or questions for populating a course curriculum. Assignment asset storage 310 may preserve descriptive tags and other metadata for each assignment asset in assignment asset storage 310. Additionally, assignment asset storage 310 may tag each assignment asset with a type of question (e.g., crossword, fill in the blank, reading comprehension, true/false) featured in the assignment asset.

FIG. 4 shows a system diagram for dynamically creating personalized assignment assets, in accordance with one or more embodiments. In particular, FIG. 4 demonstrates the process through which the system observes how a user interacts with an assignment asset and/or other content. Through the observations, the system determines the preferences of a user or information about the preferences of the user (e.g., does the user enjoy content, is the user maintaining his/her level of engagement) as well as the skill (e.g., how well did the user perform on the assignment asset, did the user interact with the content in a way the demonstrates a certain level of competence or lack thereof, etc.)

For example, the system may access assignment assets from assignment asset storage 402 (e.g., which may correspond to assignment asset storage 310 (FIG. 3)). The system may analyze (e.g., using a content and exercise selection system 404) the tags and/or requirements for an assignment asset. Content and exercise selection system 404 may compare requirements (e.g., skill level required, format type, subject matter type, etc.) to available assignment assets in assignment asset storage 402. For example, the system may continually select assignment assets that match the requirements and subject matter preferences to select an appropriate assignment asset and/or question for an assignment asset. Content and exercise selection system 404 may likewise select assignment assets and/or questions for assignment assets that address the weakness of a user. For example, the system may select assignment asset 406 that includes correct and misleading solutions as well as instructive and educational hints and teaching tools. During this process, the system may incorporate one or more of the machine learning and/or artificial neural networks as described in FIG. 2. The correct and misleading solutions may also be generated base on prior user actions via adversarial engine 410 (as discussed below).

The system may then dynamically monitor and assess (e.g., using engagement analyzer 412) the level of engagement of user 408 while user 408 is interacting with assignment asset 406. For example, engagement analyzer 412 may monitor the length of time between user inputs, may monitor other devices with which the user may interact (e.g., a mobile phone of the user), may monitor biometrics of the user and/or line-of-sight of the user to determine the level of engagement of the user. The system also monitors the user using an adversarial learning engine (e.g., adversarial engine 410) to identify areas of weakness and updating the skill level and/or subject matter preference of the user in user profile 414. The system then uses the skill level and/or subject matter preference of the user in user profile 414 to select assignment assets (e.g., using content and exercise selection system 404). As with adversarial training systems, adversarial engine 410 may generate responses aimed at directing false positives in the analysis of the user's monitored user actions. The system may use this analysis to better refine the personalization of assignment assets.

In some embodiments, adversarial engine 410 may comprise a generative neural network that is working against a discriminative neural network. For example, the discriminative neural network may attempt to classify inputted data. For example, the discriminative neural network may receive an input of words based on an assignment asset (e.g., a problem based on the assignment asset), the discriminative neural network may determine whether or not an answer (e.g., submitted by the user) is correct. In contrast, the generative neural network determines, if the answer is incorrect, what are likely variables in the answer. For example, the generative neural network may determine words or groups of words that are likely to appear in wrong answers.

The generative neural network may then submit these wrong answers to the discriminative neural network in order to determine whether or not the discriminative neural network correctly identifies the wrong answer. The output of the discriminative neural network (e.g., whether or not the answer was correctly determined to be “wrong” and/or the degree of confidence to which the discriminative neural network associated with the “wrongness” of the answer) may be used to generate wrong answers and/or generate wrong answer with a particular level of difficulty. For example, the system may parse articles to determine how to correctly use the English language for a given phrase. The system may determine that the phrase “I'm planning to go to the movies” is the correct phrase based on the frequency of use, stored grammar rules, and/or a manual selection from an instructor. The system may also locate/generate terms such as “I'm planning on going to the movies” and “I'm planning at the movies.” The system (e.g., a discriminative neural network trained on the correct phraseology) may determine that both “I'm planning on going to the movies” and “I'm planning at the movies” are incorrect. The system may also determine that “I'm planning at the movies” is more incorrect due to its scarcity, a comparison with stored grammar rules, and/or a manual selection. The system may then weigh the answer corresponding to “I'm planning at the movies” as indicating a lower skill level than the answer corresponding “I'm planning on going to the movies”.

For example, during generation of a problem with four potential answers, adversarial engine 410 may determine two wrong answers (e.g., which has a high level of confidence of “wrongness”) and one wrong answer (e.g., which has a low level of confidence of “wrongness” and is designed by the system to trick and/or provide a harder test to the user). The determine wrong answers may then be presented along with a correct answer. By introducing the variability of these answers, the system introduces a more personalized system that is better able to approximate the skill level of the user. For example, the system may determine that most users select a first wrong answer, which is wrong, but not as wrong as a second answer. Users that selected the second answer are therefore determined to have a lower skill level than those that selected the first answer.

In some embodiments, one or more of the neural networks of adversarial engine 410 may be trained on data sets of information specific to the user. For example, the data set may include content produced (e.g., prior assignments, answers) for the user as well as the user's response (e.g., correct and incorrect selections) related to that content. Adversarial engine 410 may also receive (e.g., as discussed below in relation to FIG. 5) information related to the engagement and/or skill level of the user. The system may include such information into the data set. In some embodiments, this data set may be augmented with data from other users and/or submissions from instructors related to the progress of the user.

FIG. 5 shows a system diagram for generating content based on the strengths, weakness, and/or skill level of users, in accordance with one or more embodiments. For example, as shown in FIG. 5 the system may measure the engagement and/or skill level of the user with a varying degree of granularity and using multiple qualitative and/or quantitative metrics. The system may categorize the engagement and/or skill level of the user. Each category (e.g., representations of the user's skills 502, 504,506, 508, and 512) may represents a set of related vectors, with each vector corresponding to a sub-category of the category.

In some embodiments, FIG. 5 may represent illustrative graphics that appear in a user profile (e.g., as displayed in user interface 100 (FIG. 1)). For example, FIG. 5 illustrates examples of profiles of different skills and subskills. For example, as shown in FIG. 5, the user profile (which in some embodiments may correspond to user profile 414 (FIG. 4)) may comprise representations of the user's skills 502, 504,506, 508, and 512. Each of the representations of the user's skills 502, 504,506, 508, and 512 may themselves include subskills and levels for each of these subskills.

In some embodiments, the system may determine one or more user skills that are affected by a given user action, a given assignment asset, and/or a user action on a given assignment asset. For example, the system may tag each skill category and/or subcategory with the user actions that affect it as well as an amount that the user action affects the category. In some embodiments, the system may calculate an amount of effect based on the given user action, the given assignment asset, and/or the user action on a given assignment asset.

The system may update the skills of the user based on monitoring user actions. For example, in response to correct answers, the system may increase a corresponding skill of a user. Information from adversarial engine 510, which may correspond to adversarial engine 410 (FIG. 4), engagement analyzer 514, which may correspond to engagement analyzer 412 (FIG. 4), user actions of user 518 (e.g., in-person interactions, one-on-one lessons with an instructor, video-chat, self-assessments, and electronic and non-electronic assignments, etc.), and content selected from content recommendation system 516, which may in some embodiments correspond to content and exercise selection system 404 (FIG. 4), are used to update the various skill levels of the user. These updates may used to dynamically create personalized assignment assets as discussed in FIG. 4 above.

As the system updates the quantitative or qualitative skill level of the user, the system feeds this information back to refine the selection of assignment assets and/or questions for assignment assets in order to focus on particular weaknesses and/or curriculum goals of the user. As shown in FIG. 5, the skills of the user are represented by expanding bars (e.g., as would appear in a graphic on user interface 100 (FIG. 1)). However, solely quantitative assessments (e.g., a 1-100 ranking) or a solely qualitative assessment (e.g., “expert”, “intermediate”, “beginner” classes) may also be used.

In some embodiments, the system may compare quantitative skill level of the user (e.g., a numerical score) to one or more thresholds (e.g. a threshold score) that correspond to a skill level in order to determine whether or not the quantitative skill level of the user equals or exceeds the skill level. In some embodiments, the system may compare quantitative skill level of the user (e.g., a numerical score) to one or more ranges (e.g. a threshold range) that correspond to a skill level in order to determine whether or not the quantitative skill level of the user corresponds to the skill level.

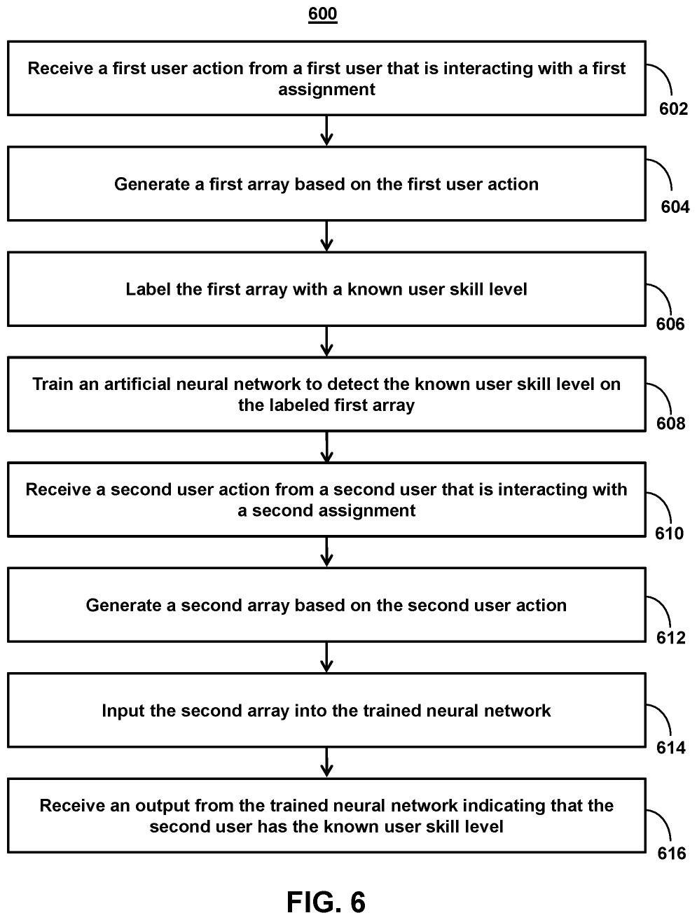

FIG. 6 shows a flowchart of steps for determining a user skill level while teaching foreign languages using a trained neural network, in accordance with one or more embodiments. For example, process 600 may represent the steps taken by one or more devices as shown in FIGS. 1-5. Additionally, process 600 may incorporate one or more of the features described in relation to FIGS. 3-5.

At step 602, process 600 (e.g., via control circuitry) receives a first user action from a first user (e.g., via user interface 100) that is interacting with a first assignment asset (e.g., a news publication as modified as described in FIG. 3). For example, the first user action (e.g., a selection of a “help” icon) may have a first characteristic (e.g., a frequency of the user selection). In some embodiments, the first user action may include metadata associated with the user action. For example, the first user action may correspond to user action 518 (FIG. 5) and include information from engagement analyzer 514 (FIG. 5).

At step 604, process 600 (e.g., via control circuitry) generates a first array based on the first user action. For example, the system may use an artificial neural network in which information is input to the neural network by first transforming the information representing the first user action into an array of values. It should be noted that an array of values may comprise a range of numerical values, a listing of values, and/or any other grouping of variables or values.

At step 606, process 600 (e.g., via control circuitry) labels the first array with a known user skill level. For example, the system may receive a known user skill level associated with the user action and/or the characteristic of the user action (e.g., as described in FIG. 5). The system may receive this information via a manual input (e.g., from an instructor), from a third party (e.g., a government, industry, or other standards organization that designates proficiency in languages), and/or based on a model prediction or similar scores/average across a population of users.

At step 608, process 600 (e.g., via control circuitry) trains an artificial neural network to detect the known user skill level on the labeled first array. For example, as described in FIG. 2 above, the system may train itself to classify given user action and/or characteristics of those actions into determined skill levels. The system may use a plurality of models and algorithms, including adversarial models for training. Additionally, the system may train the artificial neural network to detect the known user skill level based on labeled third array, wherein the labeled third array is based on a third user action from a third user that is interacting with a third assignment asset, and wherein the third user action has a third characteristic. For example, the system may determine a user skill level from multiple user actions and/or characteristics of those actions. In such cases, the system may aggregate data about the user actions into a quantitative or qualitative score. The score may then be compared to given ranges corresponding to a known skill level. For example, the system may determine a range for the second characteristic for the second user action based on the first characteristic and then determine that the second characteristic is within the range. If the second characteristic is within the range, the system may determine that the second user has the known skill level.

Additionally, the system may train the artificial neural network to detect the known user skill level based on a labeled third array, wherein the labeled third array is based on first user's self-assessed skill level. For example, the system may store a user's answer to a self-assessment question (e.g., question 106 (FIG. 1)) and use that answer to influence the determined skill level of the user. Additionally, the artificial neural network may be trained to determine the actual skill level of a user based on the user's self-assessed skill level.

At step 610, process 600 (e.g., via control circuitry) receives a second user action (e.g., a user selection of an incorrect answer to a generated question) from a second user that is interacting with a second assignment asset (e.g., a book review as modified as described in FIG. 3), wherein the second user action has a second characteristic (e.g., a number of incorrect answers in a row).

At step 612, process 600 (e.g., via control circuitry) generates a second array based on the second user action. For example, the system may transform the user action and/or characteristics of the user action into an array of values.

At step 614, process 600 (e.g., via control circuitry) inputs the second array into the trained neural network. For example, after training the artificial neural network, the system may receive user actions from another user. The user action and/or the characteristics of that user action may be input into the trained artificial neural network to determine the skill level of the second user.

At step 616, process 600 (e.g., via control circuitry) receives an output from the trained neural network indicating that the second user has the known user skill level. For example, based on the received user action, the system may determine the skill level of the user. As the artificial neural network is robust and trained on a plurality of test data, the artificial neural network may classify a skill level of the user even though the assignment, user action, and/or characteristic of the user action may be unique to the user.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-5 could be used to perform one or more of the steps in FIG. 6.

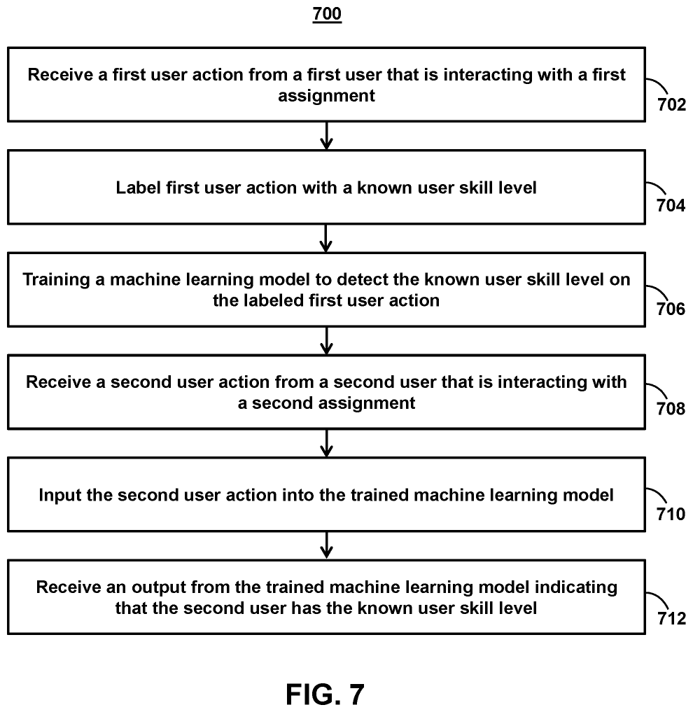

FIG. 7 shows a flowchart of steps for determining a user skill level while teaching foreign languages using a machine learning model, in accordance with one or more embodiments. For example, process 700 may represent the steps taken by one or more devices as shown in FIGS. 1-5. Additionally, process 700 may incorporate one or more of the features described in relation to FIGS. 3-5.

At step 702, process 700 (e.g., via control circuitry) receives a first user action (e.g., a selection of a user to begin a reading compression question) from a first user that is interacting with a first assignment asset (e.g., a reading comprehension question featuring a news article), wherein the first user action has a first characteristic (e.g., a length of time until a user selects an answer).

At step 704, process 700 (e.g., via control circuitry) labels first user action with a known user skill level. For example, the system may receive this information via a manual input (e.g., from an instructor), from a third party (e.g., a government, industry, or other standards organization that designates proficiency in languages), and/or based on a model prediction or similar scores/average across a population of users as described in FIG. 6 above.

At step 706, process 700 (e.g., via control circuitry) trains a machine learning model to detect the known user skill level on the labeled first user action. For example, as described in FIG. 2 above, the system may train itself to classify given user action and/or characteristics of those actions into determined skill levels. The system may use a plurality of models and algorithms, including adversarial models for training.

At step 708, process 700 (e.g., via control circuitry) receives a second user action (e.g., a selection of the user to begin a reading compression question) from a second user that is interacting with a second assignment asset (e.g., a reading comprehension question featuring an article on cooking), wherein the second user action has a second characteristic (e.g., a length of time until a user selects an answer).

At step 710, process 700 (e.g., via control circuitry) inputs the second user action into the trained machine learning model. For example, after training the artificial neural network, the system may receive user actions from another user. The user action and/or the characteristics of that user action may be input into the trained artificial neural network to determine the skill level of the second user. For example, as described in FIG. 2 above, the system may train itself to classify given user actions and/or characteristics of those actions into determined skill levels. The system may use a plurality of models and algorithms, including adversarial models for training. Additionally, the system may train the artificial neural network to detect the known user skill level based on labeled third array, wherein the labeled third array is based on a third user action from a third user that is interacting with a third assignment asset, and wherein the third user action has a third characteristic. For example, the system may determine a user skill level from multiple user actions and/or characteristics of those actions. In such cases, the system may aggregate data about the user actions into a quantitative or qualitative score. The score may then be compared to given ranges corresponding to a known skill level. For example, the system may determine a range for the second characteristic for the second user action based on the first characteristic and then determine that the second characteristic is within the range. If the second characteristic is within the range, the system may determine that the second user has the known skill level.

Additionally, the system may train the artificial neural network to detect the known user skill level based on a labeled third array, wherein the labeled third array is based on first user's self-assessed skill level. For example, the system may store a user's answer to a self-assessment question (e.g., question 106 (FIG. 1)) and use that answer to influence the determined skill level of the user. Additionally, the artificial neural network may be trained to determine the actual skill level of a user based on the user's self-assessed skill level.

At step 712, process 700 (e.g., via control circuitry) receives an output from the trained machine learning model indicating that the second user has the known user skill level. For example, based on the received user action, the system may determine the skill level of the user. As the artificial neural network is robust and trained on a plurality of test data, the artificial neural network may classify a skill level of the user even though the assignment, user action, and/or characteristic of the user action may be unique to the user.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-5 could be used to perform one or more of the steps in FIG. 7.

FIG. 8 shows a flowchart of steps for generating foreign language questions for learning foreign languages with natural language processing using a part-of-speech tagging algorithm, in accordance with one or more embodiments. For example, process 800 may represent the steps taken by one or more devices as shown in FIGS. 1-5. In some embodiments, the system may further determine the user skill level based on the processes described in FIGS. 6-7 above. Additionally, process 800 may incorporate one or more of the features described in relation to FIGS. 3-5.

At step 802, process 800 (e.g., via control circuitry) retrieves a subject matter preference of a user from a user profile. For example, as described in FIG. 1 above, the system may accumulate information about the user to tailor the user experience of that user. This may include tailoring assignment assets, content for questions, etc. to the preferences of the user.

At step 804, process 800 (e.g., via control circuitry) selects an assignment asset corresponding to the subject matter preference. For example, the system may retrieve information (e.g., from user profile 110 (FIG. 1)) that indicates a preferred genre of the user. The system may then select assignment assets in that genre. For example, the system may refer to descriptive tags assigned to different assignment assets (e.g., as described in FIG. 3) to match assignment assets to subject matter preferences of a user.

At step 806, process 800 (e.g., via control circuitry) processes the assignment asset using a part-of-speech tagging algorithm to label a first word of the assignment asset as corresponding to a first part-of-speech type and a second word of the assignment asset as corresponding to a second part-of-speech type. For example, the system may use the Viterbi algorithm, Brill tagger, Constraint Grammar, and the Baum-Welch algorithm (also known as the forward-backward algorithm) to tag words, sentences, etc. in the assignment. The system may identify one or more of the nine parts of speech in English: noun, verb, article, adjective, preposition, pronoun, adverb, conjunction, and interjection as well as additionally categories and/or subcategories.

At step 808, process 800 (e.g., via control circuitry) selects a part-of-speech type for testing in the assignment asset. For example, the system may retrieve information from the user profile (e.g., user profile 110 (FIG. 1)) that indicates that the user needs additional work on a particular part-of-speech. In response, the system may generate an assignment asset that targets that part-of-speech (e.g., using an adversarial learning engine as described in FIG. 4). For example, the system may retrieve a user skill level from a user profile and select the foreign language question corresponding to the first word based on the user skill level. Additionally or alternatively, the system may retrieve a first skill level for the first part-of-speech type from the user profile. The system may then compare the first skill level to a threshold skill level (e.g., a skill level corresponding to a projected progress through the course curriculum). The system may then select the part-of-speech type for testing in the assignment asset based on the first skill level not equaling or exceeding the threshold skill level. For example, in response to determining that the user is weak with respect to a given part-of-speech type, the system may generate an assignment asset targeting that part-of-speech type.

Additionally or alternatively, the system may retrieve a first skill level for the first part-of-speech type from a user profile. The system may also retrieve a second skill level for the second part-of-speech type from the user profile. The system may then compare the first skill level to the second skill level and select the part-of-speech type for testing in the assignment asset based on the first skill level not equaling or exceeding the second skill level. For example, the system may compare the level of skill of one or more part-of-speech types to determine what part-of-speech type is the weakest of the user. The system may generate an assignment asset targeting that part-of-speech.

Additionally or alternatively, the system may retrieve a course curriculum for learning a foreign language; and selecting the part-of-speech type for testing in the assignment asset based on the course curriculum. For example, the system may generate assignment assets according to a static or dynamic course curriculum. The course curriculum may be designed to touch on various part-of-speech types in a given order for increased efficiency.

At step 810, process 800 (e.g., via control circuitry) determines that the first part-of-speech type corresponds to the part-of-speech type for testing. For example, the system may parse the language of the assignment asset to identify a word, sentence, etc. that matches the part-of-speech type. The system may then compare the parsed content (or a tag of the parsed content) for matches. Upon detecting a match, the system selects the word, sentence, etc. for use in generating content.

At step 812, process 800 (e.g., via control circuitry) generates content for a foreign language question corresponding to the first word in response to determining that the first part-of-speech type corresponds to the part-of-speech type for testing. For example, as shown and described in FIG. 1 above, the system may generate content corresponding to the first part-of-speech type.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-5 could be used to perform one or more of the steps in FIG. 8.

FIG. 9 shows a flowchart of steps for generating foreign language questions for learning foreign languages with natural language processing using a summation algorithm, in accordance with one or more embodiments. For example, process 900 may represent the steps taken by one or more devices as shown in FIGS. 1-5. In some embodiments, the system may further determine the user skill level based on the processes described in FIGS. 6-7 above. Additionally, process 900 may incorporate one or more of the features described in relation to FIGS. 3-5.

At step 902, process 900 (e.g., via control circuitry) retrieves a subject matter preference of a user from a user profile. For example, as described in FIG. 1 above, the system may accumulate information about the user to tailor the user experience of that user. This may include tailoring assignment assets, content for questions, etc. to the preferences of the user.

At step 904, process 900 (e.g., via control circuitry) selects a first assignment asset and a second assignment asset corresponding to the subject matter preference. For example, the system may select multiple assignment assets each corresponding to a preferred topic or genre of the user. For example, the system may refer to descriptive tags assigned to different assignment assets (e.g., as described in FIG. 3) to match assignment assets to subject matter preferences of a user.

At step 906, process 900 (e.g., via control circuitry) processes the first assignment asset using a first summation algorithm to generate a first summation of the first assignment asset and processing the second assignment asset using a second summation algorithm to generate a second summation of the second assignment asset. For example, the system may use extractive and/or abstractive summarization. In extractive summarization, the system extracts important parts (e.g., based on a given metric) of the assignment asset. For example, the system may use inverse-document frequency to identify important parts. Additionally or alternatively, the system may rephrase words and use sequence-to-sequence learning algorithms as well as adversarial training models (e.g., as described in FIG. 4).

At step 908, process 900 (e.g., via control circuitry) generates content for a foreign language question using the first summation and a second summation. For example, the system may generate multiple summations of the same or different article and request the user identify the correct summation and/or the best summation of a given article.

In some embodiments, the system may select assignment assets based on a skill level of the user and/or the difficulty of an assignment article. The system may determine the skill level of the user as described in FIGS. 6-8 above. The system may also determine the skill level of an article. In some embodiments, the system may determine the skill level of the article manually (e.g., an instructor or other users may review and manually assign a skill level to the article).

Additionally or alternatively, the system may receive assignments of a skill level, and the system may average the multiple assignments to determine a skill level of the article. In some embodiments, the system may determine this automatically. For example, the system may apply natural language processing to the article to determine its complexity. For example, the system may determine that articles with longer sentences, articles with rarer words, articles with longer words, and/or articles with more punctuation. In some embodiments, the system may also use a hybrid approach. For example, the system may receive manual assignments of a skill level of an article. The system may also compare the assignment of the article to the skill level of the instructor/user that provided the assignment.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-5 could be used to perform one or more of the steps in FIG. 9.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The present techniques will be better understood with reference to the following enumerated embodiments:

1. A method of determining a user skill level while teaching foreign languages, the method comprising: receiving a first user action from a first user that is interacting with a first assignment asset, wherein the first user action has a first characteristic; generating a first array based on the first user action; labeling the first array with a known user skill level; training an artificial neural network to detect the known user skill level on the labeled first array; receiving a second user action from a second user that is interacting with a second assignment asset, wherein the second user action has a second characteristic; generating a second array based on the second user action; inputting the second array into the trained neural network; and receiving an output from the trained neural network indicating that the second user has the known user skill level.

2. The method of embodiment 1, further comprising training the artificial neural network to detect the known user skill level based on labeled third array, wherein the labeled third array is based on a third user action from a third user that is interacting with a third assignment asset, and wherein the third user action has a third characteristic.

3. The method of embodiment 1 or 2, further comprising training the artificial neural network to detect the known user skill level based on a labeled third array, wherein the labeled third array is based on first user's self-assessed skill level.

4. The method of any one of embodiments 1-3, wherein training the artificial neural network to detect the known user skill level on the labeled first array comprises: determining a range for the second characteristic for the second user action based on the first characteristic; and determining that the second characteristic is within the range.

5. A method of determining a user skill level while teaching foreign languages, the method comprising: receiving a first user action from a first user that is interacting with a first assignment asset, wherein the first user action has a first characteristic; labeling first user action with a known user skill level; training a machine learning model to detect the known user skill level on the labeled first user action; receiving a second user action from a second user that is interacting with a second assignment asset, wherein the second user action has a second characteristic; inputting the second user action into the trained machine learning model; and receiving an output from the trained machine learning model indicating that the second user has the known user skill level.

6. The method of embodiment 5, further comprising training the machine learning model to detect the known user skill level on labeled third user action, wherein the labeled third user action is from a third user that is interacting with a third assignment asset, and wherein the third user action has a third characteristic.

7. The method of embodiment 5 or 6, further comprising training the machine learning model to detect the known user skill level based on a self-assessed skill level of the first user.

8. The method of any one of embodiments 5-7, wherein training the machine learning model to detect the known user skill level on the labeled first action comprises: determining a range for the second characteristic for the second user action based on the first characteristic; and determining that the second characteristic is within the range.

9. A method of generating foreign language questions for learning foreign languages using natural language processing, the method comprising: retrieving a subject matter preference of a user from a user profile; selecting an assignment asset corresponding to the subject matter preference; processing the assignment asset using a part-of-speech tagging algorithm to label a first word of the assignment asset as corresponding to a first part-of-speech type and a second word of the assignment asset as corresponding to a second part-of-speech type; selecting a part-of-speech type for testing in the assignment asset; determining that the first part-of-speech type corresponds to the part-of-speech type for testing; and in response to determining that the first part-of-speech type corresponds to the part-of-speech type for testing, generating content for a foreign language question corresponding to the first word.

10. The method of embodiment 9, further comprising: retrieving a user skill level from a user profile; and selecting the content for the foreign language question corresponding to the first word based on the user skill level.

11. The method of embodiment 9 or 10, further comprising: retrieving a first skill level for the first part-of-speech type from a user profile; comparing the first skill level to a threshold skill level; and selecting the part-of-speech type for testing in the assignment asset based on the first skill level not equaling or exceeding the threshold skill level.

12. The method of any one of embodiments 9-11, further comprising: retrieving a first skill level for the first part-of-speech type from a user profile; retrieving a second skill level for the second part-of-speech type from the user profile; comparing the first skill level to the second skill level; and selecting the part-of-speech type for testing in the assignment asset based on the first skill level not equaling or exceeding the second skill level.

13. The method of any one of embodiments 9-11, further comprising: retrieving a course curriculum for learning a foreign language; and selecting the part-of-speech type for testing in the assignment asset based on the course curriculum.

14. The method of embodiment 13, wherein determining the user skill level comprises: training an artificial neural network to detect a known user skill level based on a labeled first user action and a labeled third user action, wherein the labeled first user action is from a first user that is interacting with a first different assignment asset, and wherein the labeled third user action is from a third user that is interacting with a third different assignment asset; receiving a second user action from the user while the user is interacting with a second different assignment asset; inputting the second user action into the trained neural network; and receiving an output from the trained neural network indicating that the user has the known user skill level.

15. The method of embodiment 13, wherein determining the user skill level comprises: training a machine learning model to detect a known user skill level based on a labeled first user action and a labeled third user action, wherein the labeled first user action is from a first user that is interacting with a first different assignment asset, and wherein the labeled third user action is from a third user that is interacting with a third different assignment asset; receiving a second user action from the user while the user is interacting with a second different assignment asset; inputting the second user action into the trained machine learning model; and receiving an output from the trained machine learning model indicating that the user has the known user skill level.

16. A method of generating content for foreign language questions for learning foreign languages using natural language processing, the method comprising: retrieving a subject matter preference of a user from a user profile; selecting a first assignment asset and a second assignment asset corresponding to the subject matter preference; processing the first assignment asset using a first summation algorithm to generate a first summation of the first assignment asset and processing the second assignment asset using a second summation algorithm to generate a second summation of the second assignment asset; and generating content for a foreign language question using the first summation and a second summation.

17. The method of embodiment 16, further comprising: retrieving a user skill level from a user profile; and selecting the first assignment asset and the second assignment asset based on the user skill level.

18. The method of embodiments 17, wherein selecting the first assignment asset and the second assignment asset based on the user skill level further comprises: retrieving a determined skill level corresponding to the first assignment asset and the second assignment asset; comparing the user skill level to the determined skill level corresponding to the first assignment asset and the second assignment asset; and determining that the user skill level corresponds to the determined skill level.

19. The method of any one of embodiments 17 or 18, wherein determining the user skill level comprises: training an artificial neural network to detect a known user skill level based on a labeled first user action and a labeled third user action, wherein the labeled first user action is from a first user that is interacting with a first different assignment asset, and wherein the labeled third user action is from a third user that is interacting with a third different assignment asset; receiving a second user action from the user while the user is interacting with a second different assignment asset; inputting the second user action into the trained neural network; and receiving an output from the trained neural network indicating that the user has the known user skill level.

20. The method of any one of embodiments 17-19, wherein determining the user skill level comprises: training a machine learning model to detect a known user skill level based on a labeled first user action and a labeled third user action, wherein the labeled first user action is from a first user that is interacting with a first different assignment asset, and wherein the labeled third user action is from a third user that is interacting with a third different assignment asset; receiving a second user action from the user while the user is interacting with a second different assignment asset; inputting the second user action into the trained machine learning model; and receiving an output from the trained machine learning model indicating that the user has the known user skill level.

21. The method of any one of embodiments 17-20, wherein training the machine learning model comprises training the machine learning model on adversarial examples.

22. A tangible, non-transitory, machine-readable medium storing instructions that when executed by a data processing apparatus cause the data processing apparatus to perform operations comprising those of any of embodiments 1-21.

23. A system comprising means for executing embodiments 1-21.

What is claimed is:

1. A method of determining a user skill level while teaching foreign languages, the method comprising:
receiving, using control circuitry, a first user action from a first user that is interacting with a first assignment asset, wherein the first user action has a first characteristic;
generating, using the control circuitry, a first array based on the first user action;
labeling, using the control circuitry, the first array with a known user skill level;
training, using the control circuitry, an artificial neural network to detect the known user skill level on the labeled first array;
receiving, using the control circuitry, a second user action from a second user that is interacting with a second assignment asset, wherein the second user action has a second characteristic;
generating, using the control circuitry, a second array based on the second user action;
inputting, using the control circuitry, the second array into the trained neural network; and
receiving, using the control circuitry, an output from the trained neural network indicating that the second user has the known user skill level.

2. The method of claim 1, further comprising training, using the control circuitry, the artificial neural network to detect the known user skill level based on labeled third array, wherein the labeled third array is based on a third user action from a third user that is interacting with a third assignment asset, and wherein the third user action has a third characteristic.

3. The method of claim 1, further comprising training, using the control circuitry, the artificial neural network to detect the known user skill level based on a labeled third array, wherein the labeled third array is based on first user's self-assessed skill level.

4. The method of claim 1, wherein training the artificial neural network to detect the known user skill level on the labeled first array comprises:
determining a range for the second characteristic for the second user action based on the first characteristic; and
determining that the second characteristic is within the range.

5. A method of determining a user skill level while teaching foreign languages, the method comprising:
receiving, using control circuitry, a first user action from a first user that is interacting with a first assignment asset, wherein the first user action has a first characteristic;
labeling, using the control circuitry, first user action with a known user skill level;
training, using the control circuitry, a machine learning model to detect the known user skill level on the labeled first user action;
receiving, using the control circuitry, a second user action from a second user that is interacting with a second assignment asset, wherein the second user action has a second characteristic;
inputting, using the control circuitry, the second user action into the trained machine learning model; and
receiving, using the control circuitry, an output from the trained machine learning model indicating that the second user has the known user skill level.

6. The method of claim 5, further comprising training, using the control circuitry, the machine learning model to detect the known user skill level on labeled third user action, wherein the labeled third user action is from a third user that is interacting with a third assignment asset, and wherein the third user action has a third characteristic.

7. The method of claim 5, further comprising training, using the control circuitry, the machine learning model to detect the known user skill level based on a self-assessed skill level of the first user.

8. The method of claim 5, wherein training the machine learning model to detect the known user skill level on the labeled first user action comprises:
determining a range for the second characteristic for the second user action based on the first characteristic; and
determining that the second characteristic is within the range.

9. A method of generating content for foreign language questions for learning foreign languages using natural language processing, the method comprising:
retrieving a subject matter preference of a user from a user profile;
selecting an assignment asset corresponding to the subject matter preference;
processing the assignment asset using a part-of-speech tagging algorithm to label a first word of the assignment asset as corresponding to a first part-of-speech type and a second word of the assignment asset as corresponding to a second part-of-speech type;
selecting a part-of-speech type for testing in the assignment asset;
determining that the first part-of-speech type corresponds to the part-of-speech type for testing; and
in response to determining that the first part-of-speech type corresponds to the part-of-speech type for testing, generating content for a foreign language question corresponding to the first word.

10. The method of claim 9, further comprising:
retrieving a user skill level from a user profile; and
selecting the content for the foreign language question corresponding to the first word based on the user skill level.

11. The method of claim 9, further comprising:
retrieving a first skill level for the first part-of-speech type from a user profile;
comparing the first skill level to a threshold skill level; and
selecting the part-of-speech type for testing in the assignment asset based on the first skill level not equaling or exceeding the threshold skill level.

12. The method of claim 9, further comprising:
retrieving a first skill level for the first part-of-speech type from a user profile;
retrieving a second skill level for the second part-of-speech type from the user profile;
comparing the first skill level to the second skill level; and
selecting the part-of-speech type for testing in the assignment asset based on the first skill level not equaling or exceeding the second skill level.

13. The method of claim 9, further comprising:
retrieving a course curriculum for learning a foreign language; and
selecting the part-of-speech type for testing in the assignment asset based on the course curriculum.

14. The method of claim 10, wherein determining the user skill level comprises:
training an artificial neural network to detect a known user skill level based on a labeled first user action and a labeled third user action, wherein the labeled first user action is from a first user that is interacting with a first different assignment asset, and wherein the labeled third user action is from a third user that is interacting with a third different assignment asset;
receiving a second user action from the user while the user is interacting with a second different assignment asset;
inputting the second user action into the trained neural network; and
receiving an output from the trained neural network indicating that the user has the known user skill level.

15. The method of claim 10, wherein determining the user skill level comprises:
training a machine learning model to detect a known user skill level based on a labeled first user action and a labeled third user action, wherein the labeled first user action is from a first user that is interacting with a first different assignment asset, and wherein the labeled third user action is from a third user that is interacting with a third different assignment asset;
receiving a second user action from the user while the user is interacting with a second different assignment asset;
inputting the second user action into the trained machine learning model; and
receiving an output from the trained machine learning model indicating that the user has the known user skill level.

16. A method of generating content for foreign language questions for learning foreign languages using natural language processing, the method comprising:
retrieving a subject matter preference of a user from a user profile;
selecting a first assignment asset and a second assignment asset corresponding to the subject matter preference;
processing the first assignment asset using a first summation algorithm to generate a first summation of the first assignment asset and processing the second assignment asset using a second summation algorithm to generate a second summation of the second assignment asset; and
generating content for a foreign language question using the first summation and a second summation.

17. The method of claim 16, further comprising:
retrieving a user skill level from a user profile; and
selecting the first assignment asset and the second assignment asset based on the user skill level.

18. The method of claim 17, wherein selecting the first assignment asset and the second assignment asset based on the user skill level further comprises:
retrieving a determined skill level corresponding to the first assignment asset and the second assignment asset;
comparing the user skill level to the determined skill level corresponding to the first assignment asset and the second assignment asset; and
determining that the user skill level corresponds to the determined skill level.

19. The method of claim 17, wherein determining the user skill level comprises:
training an artificial neural network to detect a known user skill level based on a labeled first user action and a labeled third user action, wherein the labeled first user action is from a first user that is interacting with a first different assignment asset, and wherein the labeled third user action is from a third user that is interacting with a third different assignment asset;
receiving a second user action from the user while the user is interacting with a second different assignment asset;
inputting the second user action into the trained neural network; and
receiving an output from the trained neural network indicating that the user has the known user skill level.

20. The method of claim 17, wherein determining the user skill level comprises:
training a machine learning model to detect a known user skill level based on a labeled first user action and a labeled third user action, wherein the labeled first user action is from a first user that is interacting with a first different assignment asset, and wherein the labeled third user action is from a third user that is interacting with a third different assignment asset;
receiving a second user action from the user while the user is interacting with a second different assignment asset;
inputting the second user action into the trained machine learning model; and
receiving an output from the trained machine learning model indicating that the user has the known user skill level.

21. The method of claim 20, wherein training the machine learning model comprises training the machine learning model on adversarial examples.
